(19) United States
(12) Patent Application Publication
(10) Pub. No.: US 2026/0052029 A1
(43) Pub. Date: Feb. 19, 2026

(54) METHOD, APPARATUS, AND COMPUTER-READABLE MEDIUM FOR EXECUTING OPERATIONS ON A HIERARCHICAL BLOCK CHAIN NETWORK

(71) Applicant: Kunato Inc., New York, NY (US)

(72) Inventor: Illan POREH, New York, NY (US)

(21) Appl. No.: 19/298,647

(22) Filed: Aug. 13, 2025

Related U.S. Application Data
(60) Provisional application No. 63/682,360, filed on Aug. 13, 2024.

(51) Int. Cl. H04L 9/00; G06F 21/62

(52) U.S. Cl. CPC H04L 9/50; G06F 21/6218; H04L 2209/463

(57) ABSTRACT

A method, apparatus, and computer-readable medium for executing operations on a hierarchical block chain network, including generating the hierarchical block chain network including a master block chain linked to a machine block chain, a content provider block chain, and a user block chain, receiving a plurality of requests to perform a plurality of operations on the hierarchical block chain network, the plurality of operations including executing a transfer from a user corresponding to the user sub-chain to a content provider corresponding to a content provider sub-chain that is linked to the content block and linking a user sub-chain in the one or more user sub-chains to a content block in the content block chain by updating the corresponding content block to reference the user sub-chain, and executing the plurality of operations based at least in part on detection of authorization from a majority of the three or more superusers.

### RELATED APPLICATION DATA

This application claims priority to U.S. Provisional Application No. 63/682,360, filed Aug. 13, 2024, the disclosure of which is hereby incorporated by reference in its entirety.

### BACKGROUND

Existing block chain based content distribution systems rely on public block chains to verify ownership of a particular item of content. This structure disregards privacy of participants, including content providers and users. Additionally, the transaction process on existing systems typically requires minting new blocks on large public chains, resulting in inefficient transaction block creation and unnecessary gas fees for participants. Accordingly, improvements are needed in systems for executing operations in a block chain based content distribution systems.

### BRIEF DESCRIPTION OF DRAWINGS

FIG. 1 illustrates a flowchart for executing operations on a hierarchical block chain network according to an exemplary embodiment.

FIG. 2 illustrates a diagram of a hierarchical block chain network according to an exemplary embodiment.

FIG. 3 illustrates a diagram of access controls in a hierarchical block chain network according to an exemplary embodiment.

FIG. 4 illustrates a system diagram of a system for executing operations on a hierarchical block chain network according to an exemplary embodiment.

FIG. 5 illustrates a flowchart for diluting ownership of content on the hierarchical block chain network according to an exemplary embodiment.

FIG. 6 illustrates an example of ownership and dividend dilution on the hierarchical block chain network according to an exemplary embodiment.

FIG. 7 illustrates the components of the specialized computing environment configured to perform the processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

Applicant has discovered a method, apparatus, and computer-readable medium for executing operations on a hierarchical block chain network that resolves existing problems in the field. As used herein, the terms “block chain” and “blockchain” are used interchangeably and refer to distributed digital ledgers that enables secure, transparent, and unalterable record-keeping and transaction processing.

The system of the present application includes a digital content exchange for facilitating the transfer, licensing, or distribution of digital content assets between parties over electronic networks. The digital content exchange operates as an intermediary platform that enables content creators, rights holders, and consumers to engage in transactions involving various forms of digital media, including audio, video, text, and software. The exchange leverages digital rights management (DRM) technologies and secure protocols to authenticate users, validate ownership rights, and enforce licensing agreements. Content Providers can upload, publish, and list their digital content offerings on the exchange, specifying terms of use, pricing, and distribution rights. Consumers/users can browse, search, and acquire digital content based on their preferences and requirements. The exchange facilitates secure payment processing and content delivery, ensuring that transactions are conducted efficiently and transparently. Through the digital content exchange, creators can monetize their content, users gain access to a wide range of digital products, and the exchange platform serves as a marketplace for digital content transactions in a scalable and secure manner.

The methods and systems of the present application allow for the creation and distribution of non-fungible tokens (NFTs) without incurring gas fees traditionally associated with block chain transactions. Users can mint their art, music, videos, or other digital assets into NFTs through a platform that minimizes or eliminates transaction costs, improving accessibility and affordability for creators. Additionally, the system facilitates the sharing of NFTs across various platforms, using dynamic widgets that attract audience engagement. Creators/content providers can earn real-time revenue when their NFTs are unlocked or purchased by users, with earnings generated through direct payments or advertisement placements integrated into the platform. These innovations enable seamless creation, sharing, and monetization of digital content in the form of NFTs, offering creators new opportunities to showcase their work and generate income without the overhead costs typically associated with blockchain transactions.

As described in greater detail below, the disclosed system utilizes a hierarchical block chain structure comprising multiple levels of interconnected blockchains. At the highest level (i.e., Level 1), a master block chain orchestrates and oversees the entire network. Under this master block chain (i.e., Level 2) are block chains corresponding to content providers (i.e., content creators and/or content platforms), machines, and users. At the next level (i.e., Level 3) are distinct user and content provider blockchains (referred to as “sub-chains”) for specific users and content providers. Additionally, at the lowest level (i.e., Level 4), content-specific block chains further refine the structure, providing a dedicated framework for managing and securing digital content within the overall block chain ecosystem. This nested arrangement of block chains optimizes scalability, security, and functionality across various layers of the network, accommodating diverse use cases and facilitating efficient data management and transaction processing.

The present systems and methods utilize a novel blockchain security architecture featuring distinct levels of privacy and access control tailored to different entities within the network. At the highest level, a master blockchain provides comprehensive security oversight and management for the entire ecosystem. Below this, blockchains associated with content providers, machines, and users operate within a completely private environment, ensuring maximum confidentiality and security for sensitive information. Concurrently, blockchains associated with specific content providers and users maintain a semi-private configuration, offering controlled access and visibility to authorized parties while safeguarding privacy. Additionally, content-specific blockchains are either configured as public or accessible by both users and content providers, facilitating open interaction and transactional engagement with digital content. This hierarchical approach to blockchain security optimizes data protection, privacy, and transparency based on the specific requirements and roles of different network participants.

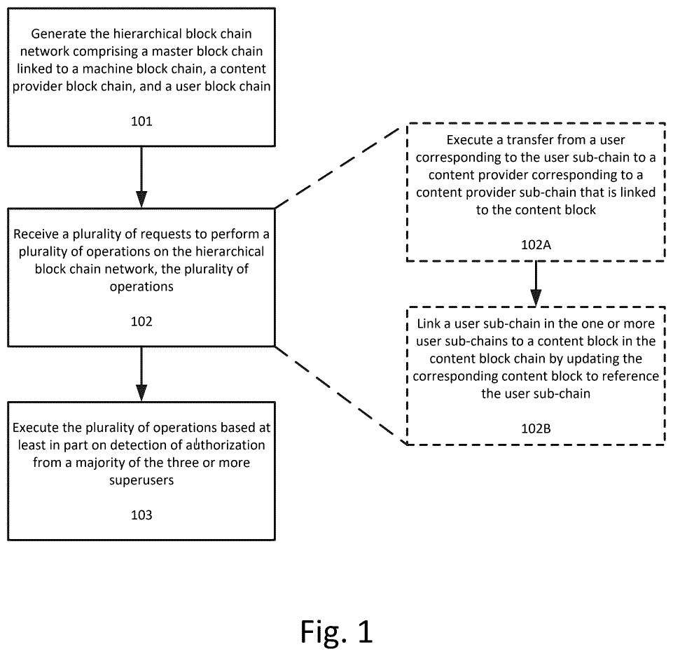

FIG. 1 illustrates a flowchart for executing operations on a hierarchical block chain network according to an exemplary embodiment. Each of the steps shown in FIG. 1 can be executed by one or more computing devices of the hierarchical block chain network. The one or more computing devices can include distributed computing devices, servers, or other machines. Additionally, the steps shown in FIG. 1 can utilize instructions encoded in a smart contract on a blockchain to perform the functionality described.

At step 101 the hierarchical block chain network is generated. The hierarchical block chain network can include a master block chain that is linked to a machine block chain, a content provider block chain, and a user block chain. The hierarchical block chain network can be generated iteratively, as new machines, content providers, users, and content are added to the network.

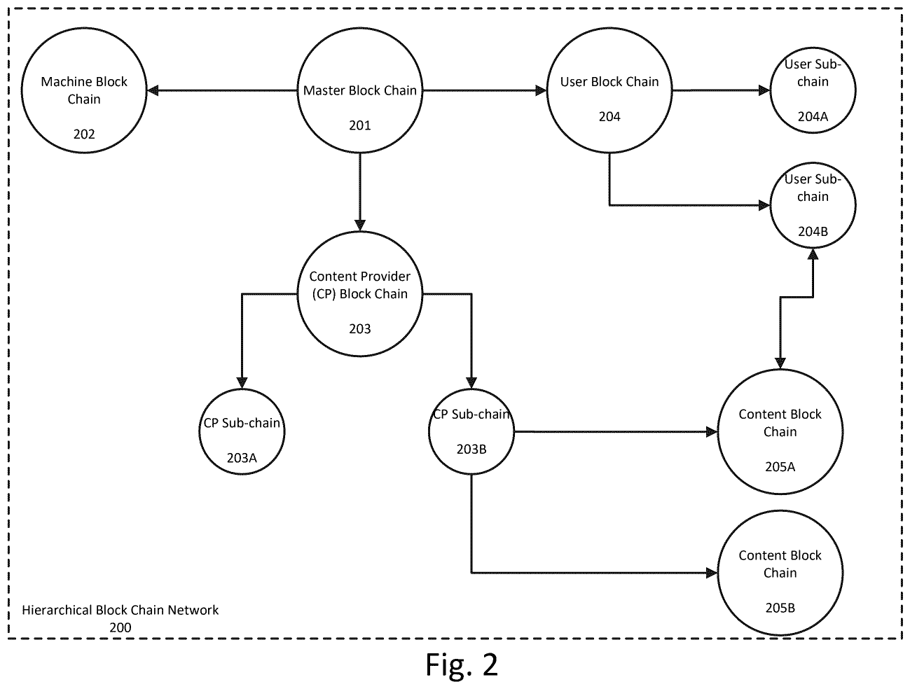

FIG. 2 illustrates a diagram of a hierarchical block chain network according to an exemplary embodiment. The hierarchical block chain network 200 includes a master block chain 201, which is a private block chain that is accessible only to superusers defined in the master block chain. The master block chain 201 can define the number of superusers. For example, the master block chain 201 can define three or more superusers. In this case, the master block chain is a private block chain accessible only to each of the three or more superusers defined in the master block chain. As discussed below, operations on the hierarchical block chain network can require approval from a majority of superusers. Therefore, the master block chain 201 can define with an odd number of superusers, to ensure that the approval process does not result in a tie or stall. Although the specification makes repeated reference to “three or more superusers,” it is understood that the number of superusers can vary and have greater or fewer superusers.

Superusers can be administrators/network coordinators/roles with access privileges to all portions of the hierarchical block chain network. As discussed above, three superuser roles can be created when the master blockchain is initiated. Superusers can have the following roles/privileges:
Adding a machine to blockchain network
Removing a machine from blockchain network
Modifying access of a machine to be read-only or write as well
Adding or removing other superusers

All superusers can be defined as being on the same level in terms of privileges/roles/authority. This ensures that a majority vote/approval of the superusers is required to perform the actions indicated above. A single superuser by itself cannot add or remove another user. However, optionally, the hierarchical block chain network and system can be configured to allow a single superuser to add a new machine without confirmation from other users. Alternatively, the process for adding a new machine can also require a majority vote/approval of the superusers.

The superusers of the present system eliminate dependency on a single entity to define how many and which machines are in the network. Superusers can also control access to the network. Rather than having a single access token known to the entire team, each member in the team can have their own set of private keys, unknown to other members.

The hierarchical block chain network can be configured to permit each superuser in the three or more superusers to add a new machine to the hierarchical block chain network. The hierarchical block chain network can additionally be configured to permit a majority of the three or more superusers to perform one or more hierarchical block chain network modifications. The one or more hierarchical block chain network modifications can include removing a machine from the hierarchical block chain network, modifying a read-write access of a machine in the hierarchical block chain network, adding a new superuser, removing an existing superuser from the hierarchical block chain network, adding a new content provider to the hierarchical block chain network, removing an existing content provider from the hierarchical block chain network, adding a new user to the hierarchical block chain network, removing an existing user from the hierarchical block chain network, adding new content to the hierarchical block chain network, removing existing content from the hierarchical block chain network, and/or adding a transaction block to the hierarchical block chain network.

The pseudo-code below illustrates different functionalities performed with the master block chain.

Initiate the blockchain with 3 superusers:

{
chainId: “master”,
hash: “m001”,
prevHash: null,
timeStamp: new Date( ),
height: 1,
data: {
chainType: “master”,
blockType: “genesis”,
superusers: [“su01”, “su02”, “su03”],
},
createdBy: “su01”,
signature: “su01_signature”,
_v: 1
}

Introduce machines to create a network:

{
chainId: “master”,
hash: “m002”,
prevHash: “m001”,
timeStamp: new Date( ),
height: 2,
data: {
blockType: “machineChain”,
chainId: “machineChainOne”,
},
createdBy: “su01”,
signature: “su01_signature”,
_v: 1
}

Reference user (sub) block chains:

{
chainId: “master”,
hash: “m003”,
prevHash: “m002”,
timeStamp: new Date( ),
height: 3,
data: {
blockType: “userChain”,
chainId: “userChainOne”,
},
createdBy: “ma01”,
signature: “ma01_signature”,
_v: 1
}

Reference to content provider (also referred to herein as “brand”) block chain:

{
chainId: “master”,
hash: “m004”,
prevHash: “m003”,
timeStamp: new Date( ),
height: 4,
data: {
blockType: “brandChain”,
chainId: “brandChainOne”,
},
createdBy: “ma01”,
signature: “ma01_signature”,
_v: 1
}

Addition of two new superusers with confirmation from two of three:

{
chainId: “master”,
hash: “m005”,
prevHash: “m004”,
timestamp: new Date( ),
height: 5,
data: {
blockType: “superuser”,
subType: “addition”,
users: [“su04”, “su05”],
verifiedBy: [
{ address: “su01”, signature: “su01_signature”
{ address: “su02”, signature: “su02_signature” }
],
},
createdBy: “ma01”,
signature: “ma01_signature”,
_v: 1
}

Removal of two super users with confirmation from three of five super users

{
chainId: “master”,
hash: “m006”,
prevHash: “m005”,
timestamp: new Date( ),
height: 6,
data: {
blockType: “superuser”,
subType: “removal”,
users: [“su03”, “su04”],
verifiedBy: [
{ address: “su01”, signature: “su01_signature” }
{ address: “su02”, signature: “su02_signature” }
{ address: “su05”, signature: “su05_signature” }
],
},
createdBy: “ma01”,
signature: “ma01_signature”,
_v: 1
}

The hierarchical block chain network 200 additionally includes a machine block chain 202 that stores machine identifiers of one or more machines of the hierarchical block chain network. The machine block chain 202 is also a private block chain accessible only to each of the three or more (or greater) superusers.

The machine block chain 202 includes information on which machines are allowed read and/or write access to the hierarchical block chain network 200. Any machine not set to active here is not responsible for adding new blocks and does not have access to the network. This approach allows developers to phase out existing machines and introduce new ones. However, as discussed above, blocks on the machine block chain 202 can only be added by a superuser (or a majority of superusers). These blocks have to be signed with the private key of an active superuser as defined in the master block chain 201 above.

The pseudo-code below illustrates blocks of the machine block chain, referenced by the master block chain:

{
chainId: “machineChainOne”,
hash: “mc01”,
prevHash: null,
timestamp: new Date( ),
height: 1,
data: {
chainType: “machine”,
blockType: “genesis”,
parentId: “master”,
block: 2
},
createdBy: “su01”,
signature: “su01_signature”,
_v: 1
},
{
chainId: “machineChainOne”,
hash: “mc02”,
prevHash: “mc01”,
timestamp: new Date( ),
height: 2,
data: {
blockType: “machine”,
machines: [
{ type: “addition”, hash: “ma01”, mtype: “readWr
{ type: “addition”, hash: “ma02”, mtype: “readWr
],
},
createdBy: “su01”,
signature: “su01_signature”,
_v: 1
},
{
chainId: “machineChainOne”,
hash: “mc03”,
prevHash: “mc02”,
timestamp: new Date( ),
height: 3,
data: {
blockType: “machine”,
machines: [
{ type: “removal”, hash: “ma01”, mtype: “read” }
{ type: “addition”, hash: “ma03”. mtype: “readWr
{ type: “role”, hash: “ma02”, mtype: “read” },
],
},
createdBy: “su01”,
signature: “su01_signature”,
_v: 1
}

The hierarchical block chain network 200 additionally includes a content provider block chain 203. The content provider block chain 203 can be a private block chain accessible only to three or more superusers defined in the master block chain. The content provider block chain 203 can include a list of all content providers on the hierarchical block chain network 200 with references to their individual sub-chains, discussed below. Each content provider can be a content creator and/or a content platform that hosts contents.

The pseudo-code below illustrates different functionalities performed with the content provider block chain (also referred to herein as the “brand” block chain).

Genesis block of brand block chain:

{
chainId: “brandChainOne”,
hash: “bl01”,
prevHash: null,
timestamp: new Date( ),
height: 1,
data: {
chainType: “brandList”,
blockType: “genesis”,
parentId: “master”,
block: 4,
},
createdBy: “ma01”,
signature: “ma01_signature”,
_v: 1
}

Add “Publisher 1” (Pub1) to brand/content provider block chain:

{
chainId: “brandChainOne”,
hash: “bl02”,
prevHash: “bl01”,
timestamp: new Date( ),
height: 2,
data: {
blockType: “brandChain”,
chainId: “Pub1Chain”,
publicKey: “Pub1”,
signature: “Yeah_this_is_me”,
},
createdBy: “ma01”,
signature: “ma01_signature”,
_v: 1
}

Add “Published 2” (Pub2) to brand/content provider blockchain:

{
chainId: “brandChainOne”,
hash: “bl03”,
prevHash: “bl02”,
timestamp: new Date( ),
height: 3,
data: {
blockType: “brandChain”,
chainId: “Pub2Chain”,
publicKey: “Pub2”,
signature: “Yeah_this_is_me”,
},
createdBy: “ma01”,
signature: “ma01_signature”,
_v: 1
}

The content provider block chain 203 includes one or more content provider sub-chains corresponding to one or more content providers, such as sub-chain 203A and 203B. Each content provider sub-chain comprises a semi-private block chain accessible to the three or more superusers and the corresponding content provider. Each content provider sub-chain links to zero or more content blocks initially. Once the content provider has published/released content, each content provider sub-chain links to at least one content block provided by the corresponding content provider in a content block chain. For example, content provider sub-chain 203B links to content block chain 205A and content block chain 205B. Unlike the master block chain 201 and machine block chain 202, the content block chains are public block chains and can be accessed by all users, as well as superusers and other parties.

Each of the content provider sub-chains contain references (i.e., links) to all content items (i.e., content blocks in the content block chain) corresponding to or provided by the content provider and also contain information regarding which users have access to publish content associated with the content provider. Specifically, the each content provider sub-chain includes a plurality of links to a plurality of content blocks provided by a corresponding content provider and one or more user identifiers corresponding to one or more users authorized to publish content associated with the corresponding content provider. For example, the blocks of the content provider sub-chains can include user identifiers or references to user blocks in the user block chain of users that are associated with a particular content provider (e.g., an employee of a digital news source).

Each of the content provider sub-chains allows the system to route payment or funds transfers from the sale of content after settlement to the corresponding content provider, as well as withdrawal of funds to back accounts referenced in the content provider sub-chains.

The pseudo-code below illustrates different functionalities performed with the content provider (i.e., brand) sub-chains. The users signing the blocks have access to add content. Additionally, other users associated with a specific content provider can also have access to add content.

Genesis block for content provider/brand sub-chain:

{
chainId: “brandOneChain”,
hash: “br01”,
prevHash: null,
timestamp: new Date( ),
height: 1,
data: {
chainType: “brand”,
blockType: “genesis”,
parentId: “brandChainOne”,
block: 2,
createdBy: “brand_user”,
signature: “brand_user_signature”,
},
createdBy: “ma01”,
signature: “ma01_signature”,
_v: 1
}

Reference to content block chain:

{
chainId: “brandOneChain”,
hash: “br02”,
prevHash: “br01”,
timestamp: new Date( ),
height: 2,
data: {
blockType: “contentChain”,
chainId: “contentItemOne”,
createdBy: “brand_user”,
signature: “brand_user_signature”,
},
createdBy: “ma01”,
signature: “ma01_signature”,
_v: 1
}

Receive funds for content item purchase/rental/transfer:

{
chainId: “brandOneChain”,
hash: “br03”,
prevHash: “br02”,
timestamp: new Date( ),
height: 3,
data: {
blockType: “sale”,
contentId: “contentItemOne”,
block: 3,
amount: “18456.48”
},
createdBy: “ma01”,
signature: “ma01_signature”,
_v: 1
}

Withdraw funds to bank account. with signature by superuser:

{
chainId: “brandOneChain”,
hash: “br04”,
prevHash: “br03”,
timestamp: new Date( ),
height: 4,
data: {
blockType: “withdraw”,
amount: “15000.0”,
// requestedBy can be optional
requestedBy: “brandUserOne”,
requestedSignature: “brandUserSignature”,
// third party reference ID
transactionReference: “paypal_a123f90bc12”,
// superuser approving the transaction
approvedBy: “su02”,
aprrovedSignature: “su02_signature”,
},
createdBy: “brand_user”,
signature: “brand_user_signature”,
_v: 1
}

The pseudo-code below illustrates different functionalities performed with the content block chain.

Creation of content block chain:

{
chainId: “contentItemOne”,
hash: “co01”,
prevHash: null,
timestamp: new Date( ),
height: 1,
data: {
chainType: “user”,
blockType: “genesis”,
publicKey: “user_1_pkey”,
parentId: “cBuzz”,
createdBy: “brandUser”,
signature: “brandUser_signature”,
ownership: “shared”
cohortShare: 0.2,
},
createdBy: “ma01”,
signature: “ma01_signature”,
_v: 1
}

Purchase by John Doe:

{
chainId: “contentItemOne”,
hash: “co02”,
prevHash: “co01”,
timestamp: new Date( ),
height: 2,
data: {
blockType: “purchase”,
amount: “13.46”,
createdBy: “johnDoe”,
signature: “johnDoe_signature”,
},
createdBy: “ma01”,
signature: “ma01_signature”,
_v: 1
}

Purchase by Jane Foster:

{
chainId: “contentItemOne”,
hash: “co03”,
prevHash: “co02”,
timestamp: new Date( ),
height: 3,
data: {
blockType: “purchase”,
amount: “15.52”,
createdBy: “janef”,
signature: “janef_signature”,
},
createdBy: “ma01”,
signature: “ma01_signature”,
_v: 1
}

Settlement block:

{
chainId: “contentItemOne”,
hash: “co03”,
prevHash: “co02”,
timestamp: new Date( ),
height: 3,
data: {
blockType: “dividend”,
transactions: [
{to: “johnDoe”, amount: “2.1146”},
{to: “cricCuzz”, amount: “18.4800356”},
{to: “_platform_”, amount: “4.12”}
]
},
createdBy: “ma01”,
signature: “ma01_signature”,
_v: 1
}

Signatures:

// For buyer
const data = {
chainId: “contentItemOne”,
amount: “123.5676”,
by: “johnDoe”
}
// For Genesis Block
const data = {
chainId: “contentItemOne”,
ownership: “shared”,
cohortShare: 0.2
}
// Machine Signature
// Machine signs everything in the block
const data = {
chainId: “contentItemOne”,
hash: “co03”,
prevHash: “co02”,
timestamp: new Date( ),
height: 3,
data: {
blockType: “dividend”,
transactions: [
{to: “johnDoe”, amount: “2.1146”}, // this is the user
{to: “cricCuzz”, amount: “18.4800356”}, // this is the content
provider/creator
{to: “_platform_”, amount: “4.12”} // this is the platform
]
// Generate signature
const signature = entity.sign(privateKey, JSON.stringify(data))

As shown in FIG. 2, the hierarchical block chain network 200 additionally includes a user block chain 204. The user block chain 204 can be a private block chain accessible only to three or more superusers defined in the master block chain. The user block chain 204 can include a list of all users on the hierarchical block chain network 200 with references to their individual sub-chains, discussed below.

The pseudo-code below illustrates different functionalities performed with the user block chain.

Genesis block:

{
chainId: “userChainOne”,
hash: “ub01”,
prevHash: null,
timestamp: new Date( ),
height: 1,
data: {
chainType: “userChain”,
blockType: “genesis”,
parentId: “master”,
block: 3
},
createdBy: “ma01”,
signature: “ma01_signature”,
_v: 1
}

Add user JohnDoe:

{
chainId: “userChainOne”,
hash: “ub02”,
prevHash: “ub01”,
timestamp: new Date( ),
height: 2,
data: {
blockType: “user”,
chainId: “JohnDoe”,
publicKey: “IamJohnDoe”,
signature: “Yeah_this_is_me”,
},
createdBy: “ma01”,
signature: “ma01_signature”,
_v: 1
}

Add User JaneF:

{
chainId: “userChainOne”,
hash: “ub03”,
prevHash: “ub02”,
timestamp: new Date( ),
height: 3,
data: {
blockType: “user”,
chainId: “JaneF”,
publicKey: “IamJane”,
signature: “Yeah_this_is_me”,
},
createdBy: “ma01”,
signature: “ma01_signature”,
_v: 1
}

The user block chain 204 includes one or more user sub-chains corresponding to one or more users, such as user sub-chain 204A and user sub-chain 204B. Each user sub-chain can be a semi-private block chain accessible to the three or more superusers and the corresponding user. The user sub-chains can link to at least one content block at least partially owned by the corresponding user in the content block chain. For example, user sub-chain 204B links to content block chain 205A. This link (and all other links described herein) can be references in the block chain to an address/location in the content block chain. The address/location in the content block chain can list the ownership of a particular item of content. Of course, if a particular user does not own any content, then their corresponding user sub-chain does not link to any content blocks.

The user sub-chains are the ledgers of the end users and can include a variety of information pertaining to a corresponding user and the user's transactions. The user sub-chains can include information regarding the public key of the user, the transaction history and current account balance of the user, ownership of content items, dividends associated with content items, funds loaded into a wallet of a user, withdrawals of funds from a wallet by the user.

The pseudo-code below illustrates blocks of user sub-chains.

Genesis block:

{
chainId: “johnDoe”,
hash: “a768”,
prevHash: null,
timestamp: new Date( ),
height: 1,
data: {
chainType: “user”,
blockType: “genesis”,
publicKey: “user_1_pkey”,
parentId: “userListOne”
},
createdBy: “ma01”,
signature: “ma01_signature”,
_v: 1
}

Credit transaction:

{
chainId: “johnDoe”,
hash: “b13a”,
prevHash: “9ca3”,
timestamp: new Date( ),
height: 2,
data: {
blockType: “credit”,
amount: “1200.0”,
transactionId: “stripe_898c9d898ed90c”,
},
createdBy: “ma01”,
signature: “ma01_signature”,
_v: 1
}

Purchase:

{
chainId: “johnDoe”,
hash: “b13a”,
prevHash: “9ca3”,
timestamp: new Date( ),
height: 3,
data: {
blockType: “purchase”,
contentId: “contentItemOne”,
block: 2
amount: “13.46”,
},
createdBy: “ma01”,
signature: “ma01_signature”,
_v: 1
}

Dividend:

{
chainId: “johnDoe”,
hash: “24bc”,
prevHash: “b13a”,
timestamp: new Date( ),
height: 4,
data: {
blockType: “dividend”,
contentId: “contentId”,
block: 3,
amount: “2.1146”
},
createdBy: “ma01”,
signature: “ma01_signature”,
_v: 1
}

Withdrawal via paypal:

{
chainId: “johnDoe”,
hash: “12cd”,
prevHash: “24bc”,
timestamp: new Date( ),
height: 5,
data: {
blockType: “withdraw”,
amount: “2.1146”,
transactionId: “paypal_898cd998a2”,
approvedBy: “su02”
},
createdBy: “ma01”,
signature: “ma01_signature”,
_v: 1
}

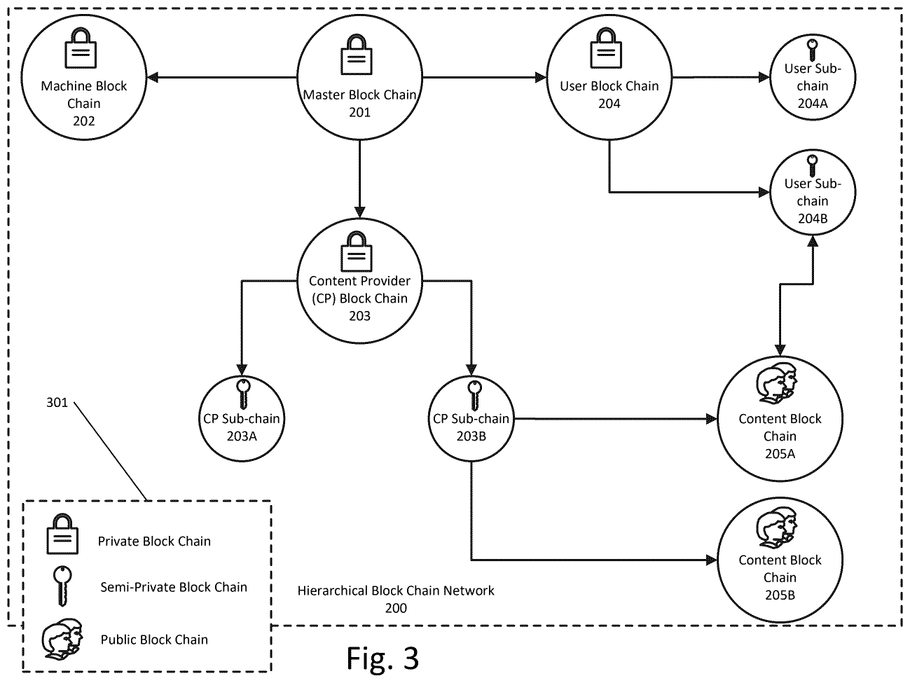

As discussed previously, a key innovation of the disclosed hierarchical block network is the use of a privacy and access control infrastructure that provides varying privileges and access controls for different interconnected block chains. FIG. 3 illustrates a diagram of access controls in a hierarchical block chain network according to an exemplary embodiment. As shown in the key 301, block chains having a “lock” icon are private block chains, accessible and editable only by superusers of the hierarchical block chain network 200. These include master block chain 201, machine block chain 202, content provider block chain 203, and user block chain 204. Additionally, block chains having a “key” icon are semi-private block chains, accessible and editable by superusers of the hierarchical block chain network, as well as by private parties that own/correspond to the relevant block chains, but not to other parties. These include content provider sub-chain 203A, content provider sub-chain 203B, user sub-chain 204A, and user sub-chain 204B. Furthermore, block chains having a “users” icon are public block chains accessible to all users and parties. These include content block chain 205A and content block chain 205B.

Returning to FIG. 1, at step 102 a plurality of requests to perform a plurality of operations on the hierarchical block chain network are received. The operations can include operations to transfer content ownership, grant access to content, buy/sell content, transfer funds/payments, add/remove content to the hierarchical block chain network, add/remove machines to the hierarchical block chain network, add/remove users to the hierarchical block chain network, add/remove content to the hierarchical block chain network, modify machine permissions and privileges, modify content ownership or dividends, modify user privileges or access rights, add/remove superusers, or any other operations on the hierarchical block network.

The plurality of operations can include operations corresponding to the transfer of content. In this case, the operations can include steps 102A and 102B. Step 102A corresponds to the execution of a transfer from a user corresponding to the user sub-chain to a content provider corresponding to a content provider sub-chain that is linked to the content block. This step corresponds to a payment made from a user to a content provider for a specific item of content referenced by a content block. Step 102B corresponds to the linkage of a user sub-chain in the one or more user sub-chains to a content block in the content block chain by updating the corresponding content block to reference the user sub-chain. This step corresponds to granting the user access to the content and/or ownership of the content in response to the payment by linking the user sub-chain of the user with the content block storing information about the content in the content block chain. This can be performed by modifying the content block to reference the user sub-chain, as well as by modifying the user sub-chain to include references to the content block.

At step 103 the plurality of operations are executed based at least in part on detection of authorization from a majority of the three or more superusers. The authorization can detected in a variety of ways. For example, the majority of the three or more superusers can sign the transaction blocks corresponding to the plurality of operations, resulting in the system permitting execution of the transaction blocks. Additionally, a voting or polling process can be used to solicit the approval or disapproval of superusers for each of the operations and the operations that receive majority approval can then be executed. Smart contracts can be utilized, along with computer program instructions stored on machines of the hierarchical block chain network to perform the required processes to ensure that only operations receiving majority approval are executed. Of course, as discussed previously, exceptions can also be defined, such as the ability of a single superuser to add new machines to the hierarchical block chain network.

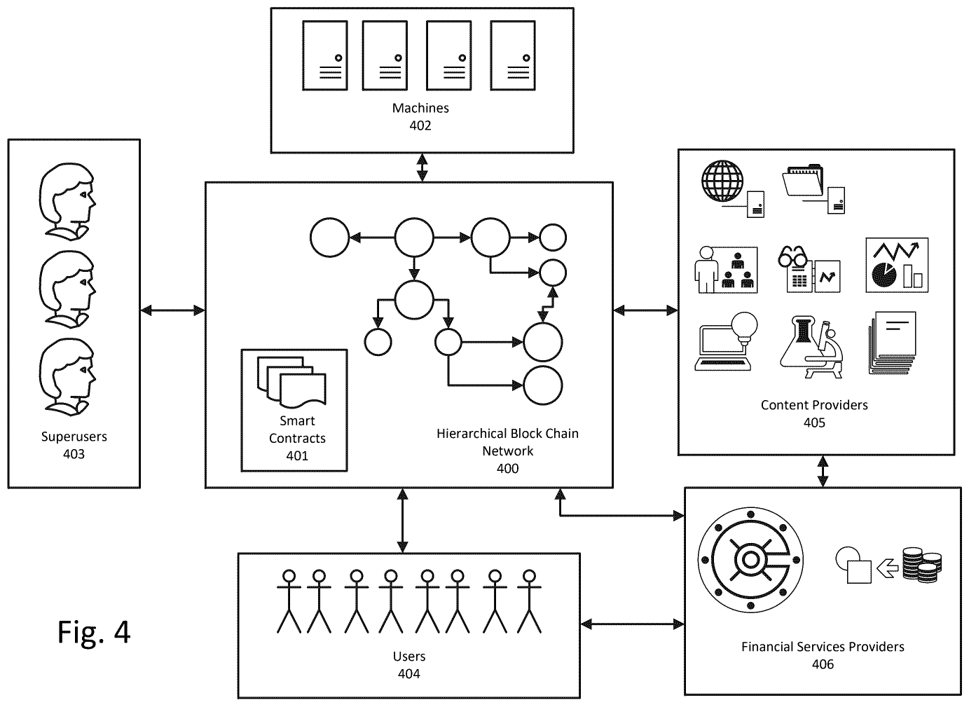

FIG. 4 illustrates a system diagram of a system for executing operations on a hierarchical block chain network according to an exemplary embodiment. Superusers 403 and their associated computing devices and private keys are used to approve changes to the hierarchical block chain network 400, as discussed above. Machines 402 implement and store the hierarchical block chain network 400 and are identified in the machine block chain. Content providers 405 correspond to the content provider sub-chains and can include content creators and/or content platforms that host content that is referenced by the content block chain. Users 404 and their associated computing devices and private keys correspond to the user sub-chains that access and transact on the hierarchical block chain network 400. Additionally, financial services providers 406 can include cryptographic wallets, bank accounts, or other financial services providers that facilitate the transfer of funds between users, content providers, and other entities on the hierarchical block chain network 400.

As shown in FIG. 4, the system can additionally include one or more smart contracts 401 that define conditions, rules, and procedures for performing the steps and operations described above. The hierarchical block chain network 400 and other entities (e.g., superusers 403, machines 402, content providers 405, users 404, and financial services providers 406) can interface with one or more smart contracts 401 to perform the operations described herein.

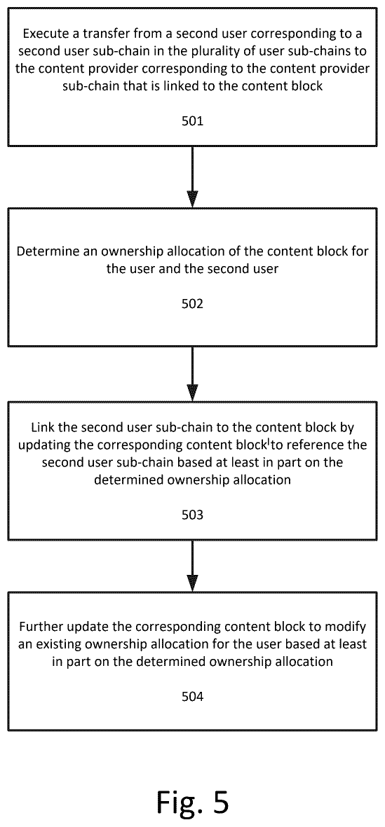

The present system enables users of the system to share ownership of digital assets by diluting ownership when more than one user purchases a particular item of content. FIG. 5 illustrates a flowchart for diluting ownership of content on the hierarchical block chain network according to an exemplary embodiment. The steps shown in FIG. 5 can be executed after the steps shown in FIG. 1, after a first user has already acquired ownership of content referenced in a content block.

At step 501 a transfer from a second user corresponding to a second user sub-chain in the plurality of user sub-chains to the content provider corresponding to the content provider sub-chain that is linked to the content block is executed. This step corresponds to the second user transferring funds to the content provider of the content for at least partial ownership of the content.

At step 502 an ownership allocation of the content block is determined for the user and the second user. The ownership allocation can be determined based on the number of existing owners, the prices paid by each of the existing owners for the content, and/or some combination of the two.

At step 503 the second user sub-chain is linked to the content block by updating the corresponding content block to reference the second user sub-chain based at least in part on the determined ownership allocation. This step can include adding a reference to the sub-chain of the second user into the content block corresponding to the content, as well as adding a reference in content block to the sub-chain of the second user.

At step 504 the corresponding content block is further updated to modify an existing ownership allocation for the (first) user based at least in part on the determined ownership allocation. This step reduces the existing ownership allocation of the first user based at least in part on the ownership allocation to the second user. Again, this step can include updating the reference to the content block in the sub-chain of the first user, as well as adding updating the reference in the content block to the sub-chain of the first user.

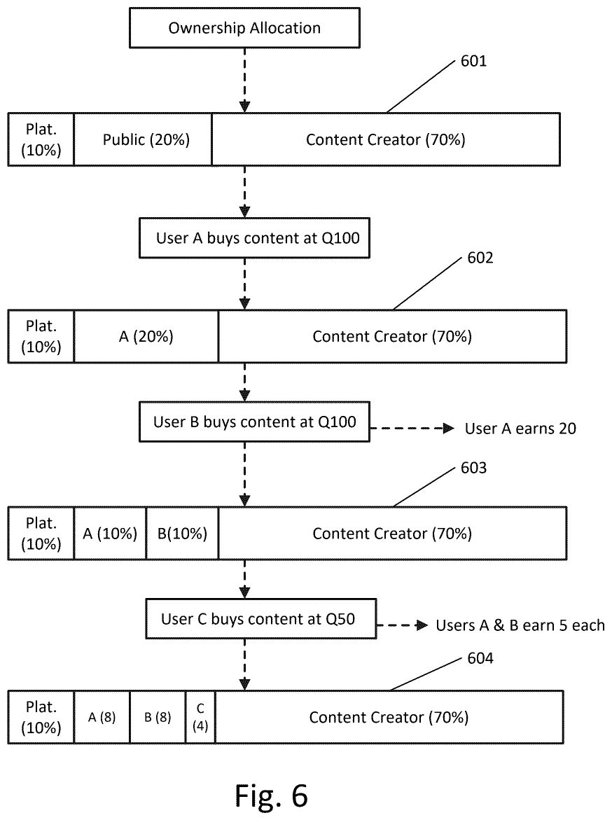

Ownership of content and/or a digital asset can allow owners to receive dividends when the content is purchased and/or rented. Similar to ownership, dividends can also be divided among owners. FIG. 6 illustrates an example of ownership and dividend dilution on the hierarchical block chain network according to an exemplary embodiment.

The example in FIG. 6 illustrates a digital asset with an ownership allocation 601 of 20% public, 70% content creator, and 10% platform ownership. This ownership allocation can be determined by the hierarchical block chain network and/or by a combination of participants in the hierarchical block chain network, such as content providers, users, superusers, or some combination of participants. The ownership allocation can vary based on the type of content and other factors. The ownership allocation 601 indicates the template for ownership based on purchases, but prior to an actual purchase by a user, the content creator can own 90%.

After User A buys content at a price of 100 (Quantity 100), then the ownership allocation is updated 602. The updated allocation 602 indicates that User A owns 20% of the content, with the platform and content creator allocations remaining unchanged. User A will receive 20% of all future earnings, unless their ownership gets diluted.

When User B buys content at a price of 100 (Quantity 100), then User A can earn a dividend of 20 (i.e., 20% of 100, corresponding to User A's ownership stake). The ownership allocation can then be updated to dilute ownership between User A and User B. The updated ownership allocation 603 indicates that User A owns 10% and User B owns 10%, with the platform and content creator allocations remaining unchanged. After this transaction, User A and User B will receive 10% of future earnings.

When User C buys content at a price of 50 (Quantity 50), then User A and User B earn a dividend of 5 each (i.e., 10% of 50, corresponding to their ownership stakes). The ownership allocation can then be updated to dilute ownership between User A, User B, and User C. The updated ownership allocation 604 indicates that User A owns 8%, User B owns 8%, and User C owns 4%, with the platform and content creator allocations remaining unchanged. The users will receive dividends from future transactions in accordance with these percentages.

Ownership and dividends can be calculated on a per transaction basis, since ownership changes with each buy in. The equation below shows the calculation of ownership for User B:

$$MyOwnership = \frac{{P}_{me}}{{\sum }_{i = 1}^{n} {P}_{i}} \times {O}_{cohort} \\ where : \{ \begin{matrix}{P}_{me} = Your purchase price ( investment amount ) \\ {P}_{i} = Purchase price of paticipant i \\ n = Total number of participants \\ {O}_{cohort} = Total ownership allocated to the cohort\end{matrix}$$

The equation below shows the dividend of User B from the purchase by User C:

$$dividend = MyOwnership * TransationAmount \\ dividend = 10 \% * Q 50 \\ dividend = 0.1 * 50 = Q 5$$

The equation below shows the calculation of ownership of User C:

$$MyOwnership = \frac{MyPurchasePrice}{SumOfAllPurchases} * CohortOwnership \\ MyOwnership = \frac{50}{100 + 100 + 50} * \text{.2} = 0.04 = 4 \%$$

Amounts can be saved on the block chain network as strings in a micro-currency unit, wherein 1 currency unit is equal to 1e20 micro-currency units. For signing blocks associated with transactions and otherwise, the system can use Elliptic Curve Digital Signature Algorithm (ECDSA) with elliptical curve 25519. Signatures can be part of the block hash, which are Secure Hash Algorithm (SHA) 256.

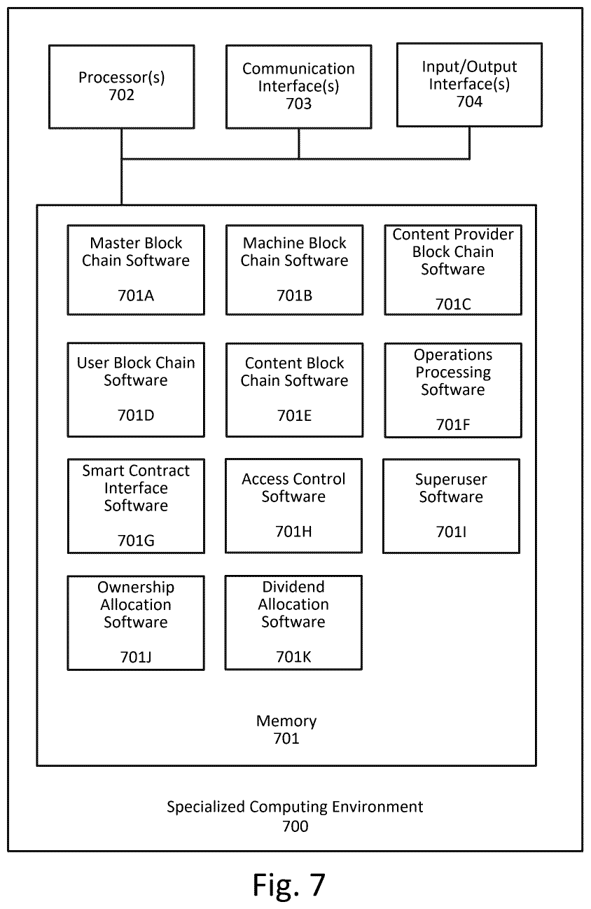

FIG. 7 illustrates the components of the specialized computing environment configured to perform the processes described herein. Specialized computing environment 700 is a computing device that includes a memory 701 that is a non-transitory computer-readable medium and can be volatile memory (e.g., registers, cache, RAM), non-volatile memory (e.g., ROM, EEPROM, flash memory, etc.), or some combination of the two.

As shown in FIG. 7, memory 701 can include master block chain software 701A, machine block chain software 701B, content provider block chain software 701C, user block chain software 701D, content block chain software 701E, operations processing software 701F, smart contract interface software 701G, access control software 701H, superuser software 701I, ownership allocation software 701J, and dividend allocation software 701K. Each of the software components in memory 701 store specialized instructions and data structures configured to perform the corresponding functionality and techniques described herein.

All of the software stored within memory 701 can be stored as a computer-readable instructions, that when executed by one or more processors 702, cause the processors to perform the functionality described with respect to FIGS. 1-6.

Processor(s) 702 execute computer-executable instructions and can be real or virtual processors. In a multi-processing system, multiple processors or multicore processors can be used to execute computer-executable instructions to increase processing power and/or to execute certain software in parallel.

Specialized computing environment 700 additionally includes a communication interface 703, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 700 further includes input and output interfaces 704 that allow users (such as system administrators) to provide input to the system to set parameters, to edit data stored in memory 701, or to perform other administrative functions.

An interconnection mechanism (shown as a solid line in FIG. 7), such as a bus, controller, or network interconnects the components of the specialized computing environment 700.

Input and output interfaces 704 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 700.

Specialized computing environment 700 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 700.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure as defined by the appended claims.

1. A method executed by one or more computing device for executing operations on a hierarchical block chain network, the method comprising:
generating the hierarchical block chain network comprising a master block chain linked to a machine block chain, a content provider block chain, and a user block chain, wherein:
the master block chain comprises a private block chain accessible only to three or more superusers defined in the master block chain;
the machine block chain stores machine identifiers of one or more machines of the hierarchical block chain network, the machine block chain comprising a private block chain accessible only to the three or more superusers;
the content provider block chain comprises one or more content provider sub-chains corresponding to one or more content providers, each content provider sub-chain comprising a semi-private block chain accessible to the three or more superusers and the corresponding content provider, wherein each content provider sub-chain links to at least one content block provided by the corresponding content provider in a content block chain, the content block chain comprising a public block chain; and
the user block chain comprises one or more user sub-chains corresponding to one or more users, each user sub-chain comprising a semi-private block chain accessible to the three or more superusers and the corresponding user, wherein each user sub-chain links to at least one content block at least partially owned by the corresponding user in the content block chain;
receiving a plurality of requests to perform a plurality of operations on the hierarchical block chain network, the plurality of operations comprising:
executing a transfer from a user corresponding to the user sub-chain to a content provider corresponding to a content provider sub-chain that is linked to the content block; and
linking a user sub-chain in the one or more user sub-chains to a content block in the content block chain by updating the corresponding content block to reference the user sub-chain; and
executing the plurality of operations based at least in part on detection of authorization from a majority of the three or more superusers.

2. The method of claim 1, wherein the hierarchical block chain network is configured to permit each superuser in the three or more superusers to add a new machine to the hierarchical block chain network.

3. The method of claim 1, wherein the hierarchical block chain network is configured to permit a majority of the three or more superusers to perform one or more hierarchical block chain network modifications.

4. The method of claim 3, wherein the one or more hierarchical block chain network modifications comprise one or more of:
removing a machine from the hierarchical block chain network;
modifying a read-write access of a machine in the hierarchical block chain network;
adding a new superuser;
removing an existing superuser from the hierarchical block chain network;
adding a new content provider to the hierarchical block chain network;
removing an existing content provider from the hierarchical block chain network;
adding a new user to the hierarchical block chain network;
removing an existing user from the hierarchical block chain network;
adding new content to the hierarchical block chain network;
removing existing content from the hierarchical block chain network; or
adding a transaction block to the hierarchical block chain network.

5. The method of claim 1, wherein each content provider sub-chain in the one or more content provider sub-chains comprises:
a plurality of links to a plurality of content blocks provided by a corresponding content provider; and
one or more user identifiers corresponding to one or more users authorized to publish content associated with the corresponding content provider.

6. The method of claim 1, wherein each content provider in the one or more content providers comprises one of a content creator or a content platform.

7. The method of claim 1, wherein the one or more user sub-chains comprise a plurality of user sub-chains and further comprising:
executing a transfer from a second user corresponding to a second user sub-chain in the plurality of user sub-chains to the content provider corresponding to the content provider sub-chain that is linked to the content block;
determining an ownership allocation of the content block for the user and the second user;
linking the second user sub-chain to the content block by updating the corresponding content block to reference the second user sub-chain based at least in part on the determined ownership allocation; and
further updating the corresponding content block to modify an existing ownership allocation for the user based at least in part on the determined ownership allocation.

8. An apparatus for executing operations on a hierarchical block chain network, the apparatus comprising:
one or more processors; and
one or more memories operatively coupled to at least one of the one or more processors and having instructions stored thereon that, when executed by at least one of the one or more processors, cause at least one of the one or more processors to:
generate the hierarchical block chain network comprising a master block chain linked to a machine block chain, a content provider block chain, and a user block chain, wherein:
the master block chain comprises a private block chain accessible only to three or more superusers defined in the master block chain;
the machine block chain stores machine identifiers of one or more machines of the hierarchical block chain network, the machine block chain comprising a private block chain accessible only to the three or more superusers;
the content provider block chain comprises one or more content provider sub-chains corresponding to one or more content providers, each content provider sub-chain comprising a semi-private block chain accessible to the three or more superusers and the corresponding content provider, wherein each content provider sub-chain links to at least one content block provided by the corresponding content provider in a content block chain, the content block chain comprising a public block chain; and
the user block chain comprises one or more user sub-chains corresponding to one or more users, each user sub-chain comprising a semi-private block chain accessible to the three or more superusers and the corresponding user, wherein each user sub-chain links to at least one content block at least partially owned by the corresponding user in the content block chain;
receive a plurality of requests to perform a plurality of operations on the hierarchical block chain network, the plurality of operations comprising:
executing a transfer from a user corresponding to the user sub-chain to a content provider corresponding to a content provider sub-chain that is linked to the content block; and
linking a user sub-chain in the one or more user sub-chains to a content block in the content block chain by updating the corresponding content block to reference the user sub-chain; and
execute the plurality of operations based at least in part on detection of authorization from a majority of the three or more superusers.

9. The apparatus of claim 8, wherein the hierarchical block chain network is configured to permit each superuser in the three or more superusers to add a new machine to the hierarchical block chain network.

10. The apparatus of claim 8, wherein the hierarchical block chain network is configured to permit a majority of the three or more superusers to perform one or more hierarchical block chain network modifications.

11. The apparatus of claim 10, wherein the one or more hierarchical block chain network modifications comprise one or more of:
removing a machine from the hierarchical block chain network;
modifying a read-write access of a machine in the hierarchical block chain network;
adding a new superuser;
removing an existing superuser from the hierarchical block chain network;
adding a new content provider to the hierarchical block chain network;
removing an existing content provider from the hierarchical block chain network;
adding a new user to the hierarchical block chain network;
removing an existing user from the hierarchical block chain network;
adding new content to the hierarchical block chain network;
removing existing content from the hierarchical block chain network; or
adding a transaction block to the hierarchical block chain network.

12. The apparatus of claim 8, wherein each content provider sub-chain in the one or more content provider sub-chains comprises:
a plurality of links to a plurality of content blocks provided by a corresponding content provider; and
one or more user identifiers corresponding to one or more users authorized to publish content associated with the corresponding content provider.

13. The apparatus of claim 8, wherein each content provider in the one or more content providers comprises one of a content creator or a content platform.

14. The apparatus of claim 8, wherein the one or more user sub-chains comprise a plurality of user sub-chains and wherein at least one of the one or more memories has further instructions stored thereon that, when executed by at least one of the one or more processors, cause at least one of the one or more processors to:
executing a transfer from a second user corresponding to a second user sub-chain in the plurality of user sub-chains to the content provider corresponding to the content provider sub-chain that is linked to the content block;
determining an ownership allocation of the content block for the user and the second user;
linking the second user sub-chain to the content block by updating the corresponding content block to reference the second user sub-chain based at least in part on the determined ownership allocation; and
further updating the corresponding content block to modify an existing ownership allocation for the user based at least in part on the determined ownership allocation.

15. At least one non-transitory computer-readable medium storing computer-readable instructions for executing operations on a hierarchical block chain network that, when executed by one or more computing devices, cause at least one of the one or more computing devices to:
generate the hierarchical block chain network comprising a master block chain linked to a machine block chain, a content provider block chain, and a user block chain, wherein:
the master block chain comprises a private block chain accessible only to three or more superusers defined in the master block chain;
the machine block chain stores machine identifiers of one or more machines of the hierarchical block chain network, the machine block chain comprising a private block chain accessible only to the three or more superusers;
the content provider block chain comprises one or more content provider sub-chains corresponding to one or more content providers, each content provider sub-chain comprising a semi-private block chain accessible to the three or more superusers and the corresponding content provider, wherein each content provider sub-chain links to at least one content block provided by the corresponding content provider in a content block chain, the content block chain comprising a public block chain; and
the user block chain comprises one or more user sub-chains corresponding to one or more users, each user sub-chain comprising a semi-private block chain accessible to the three or more superusers and the corresponding user, wherein each user sub-chain links to at least one content block at least partially owned by the corresponding user in the content block chain;
receive a plurality of requests to perform a plurality of operations on the hierarchical block chain network, the plurality of operations comprising:
executing a transfer from a user corresponding to the user sub-chain to a content provider corresponding to a content provider sub-chain that is linked to the content block; and
linking a user sub-chain in the one or more user sub-chains to a content block in the content block chain by updating the corresponding content block to reference the user sub-chain; and
execute the plurality of operations based at least in part on detection of authorization from a majority of the three or more superusers.

16. The at least one non-transitory computer-readable medium of claim 15, wherein the hierarchical block chain network is configured to permit each superuser in the three or more superusers to add a new machine to the hierarchical block chain network.

17. The at least one non-transitory computer-readable medium of claim 15, wherein the hierarchical block chain network is configured to permit a majority of the three or more superusers to perform one or more hierarchical block chain network modifications.

18. The at least one non-transitory computer-readable medium of claim 17, wherein the one or more hierarchical block chain network modifications comprise one or more of:
removing a machine from the hierarchical block chain network;
modifying a read-write access of a machine in the hierarchical block chain network;
adding a new superuser;
removing an existing superuser from the hierarchical block chain network;
adding a new content provider to the hierarchical block chain network;
removing an existing content provider from the hierarchical block chain network;
adding a new user to the hierarchical block chain network;
removing an existing user from the hierarchical block chain network;
adding new content to the hierarchical block chain network;
removing existing content from the hierarchical block chain network; or
adding a transaction block to the hierarchical block chain network.

19. The at least one non-transitory computer-readable medium of claim 15, wherein each content provider sub-chain in the one or more content provider sub-chains comprises:
a plurality of links to a plurality of content blocks provided by a corresponding content provider; and
one or more user identifiers corresponding to one or more users authorized to publish content associated with the corresponding content provider.

20. The at least one non-transitory computer-readable medium of claim 15, wherein each content provider in the one or more content providers comprises one of a content creator or a content platform.

21. The at least one non-transitory computer-readable medium of claim 15, wherein the one or more user sub-chains comprise a plurality of user sub-chains and further storing computer-readable instructions that, when executed by at least one of the one or more computing devices, cause at least one of the one or more computing devices to:
executing a transfer from a second user corresponding to a second user sub-chain in the plurality of user sub-chains to the content provider corresponding to the content provider sub-chain that is linked to the content block;
determining an ownership allocation of the content block for the user and the second user;
linking the second user sub-chain to the content block by updating the corresponding content block to reference the second user sub-chain based at least in part on the determined ownership allocation; and
further updating the corresponding content block to modify an existing ownership allocation for the user based at least in part on the determined ownership allocation.
